(19) United States
(12) Patent Application Publication
(10) Pub. No.: US 2019/0289628 A1
(43) Pub. Date: Sep. 19, 2019

(54) UE USING UPLINK GRANT-BASED TRANSMISSIONS AND EXTENDED POWER GRANT-FREE NOMA TRANSMISSIONS

(71) Applicants: Gang Xiong, Beaverton, OR (US); Debdeep Chatterjee, San Jose, CA (US); Hwan-Joon Kwon, Portland, OR (US); Sergey Sosnin, Zavolzhie (RU); Yongjun Kwak, Portland, OR (US); Jose Armando Oviedo, Santa Cruz, CA (US)

(72) Inventors: Gang Xiong, Beaverton, OR (US); Debdeep Chatterjee, San Jose, CA (US); Hwan-Joon Kwon, Portland, OR (US); Sergey Sosnin, Zavolzhie (RU); Yongjun Kwak, Portland, OR (US); Jose Armando Oviedo, Santa Cruz, CA (US)

(21) Appl. No.: 16/408,924

(22) Filed: May 10, 2019

Related U.S. Application Data
(60) Provisional application No. 62/670,575, filed on May 11, 2018.
(60) Provisional application No. 62/697,812, filed on Jul. 13, 2018.

(51) Int. Cl. H04W 72/14; H04W 72/04; H04W 52/36; H04L 29/06; H04W 76/27

(52) U.S. Cl. CPC H04W 72/14; H04W 72/0446; H04W 76/27; H04L 69/22; H04W 52/365

(57) ABSTRACT

Systems and methods of providing a NOMA transmission are described. A UE, may determine, while using grant-free UL NOMA transmission in a slot to a gNB, whether to transmit to the gNB an indication for a grant-based UL NOMA transmission in a later slot. In response to a determination to continue grant-free transmission, if the grant-free transmission comprises repetitions of a TB transmission, a power of the TB transmissions is dependent on a number of repetitions remaining and a total number of repetitions or on higher layer signaling from the gNB. A grant-based transmission request and grant-free UL data are sent to the gNB in the slot if the grant-based transmission is to be used in the later slot, and the repetitions of the TB transmission in accordance with the power are sent if the grant-free transmission is to be used in the later slot.

This application claims the benefit of priority under 35 U.S.C. to U.S. Provisional Patent Application Ser. No. 62/670,575, filed May 11, 2018, and U.S. Provisional Patent Application Ser. No. 62/697,812, filed Jul. 13, 2018, each of which is incorporated herein by reference in its entirety.

### TECHNICAL FIELD

Embodiments pertain to radio access networks (RANs). Some embodiments relate to cellular networks, including Third Generation Partnership Project (3GPP) 5^{th} generation (5G) New Radio (NR) (or next generation (NG)) networks. Some embodiments relate to non-orthogonal multiple access (NOMA) transmissions. In particular, some embodiments relate to grant-free NOMA transmissions and NOMA transmissions with multi-slot repetition.

### BACKGROUND

The use of various types of systems has increased due to both an increase in the types of devices user equipment (UEs) using network resources as well as the amount of data and bandwidth being used by various applications, such as video streaming, operating on these UEs. To increase the ability of the network to contend with the explosion in network use and variation, the next generation of communication systems is being created. With the advent of any new technology, the introduction of a complex new communication system engenders a large number of issues to be addressed both in the system itself and in compatibility with previous systems and devices. Such issues arise, for example, in establishing a grant structure for uplink (UL) communications in NR networks.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1 illustrates combined communication system in accordance with some embodiments.

FIG. 2 illustrates a block diagram of a communication device in accordance with some embodiments.

FIG. 3 illustrates an UL NOMA transmission in accordance with some embodiments.

FIG. 4 illustrates application of a grant-based transmission request (GTR) sequence mask in accordance with some embodiments.

FIG. 5 illustrates GTR use in accordance with some embodiments.

FIG. 6 illustrates a GTR dedicated channel in accordance with some embodiments.

FIG. 7 illustrates GTR puncturing in accordance with some embodiments.

FIG. 8 illustrates a multi-slot transmission in accordance with some embodiments.

FIG. 9 illustrates multi-slot NOMA TB repetition in accordance with some embodiments.

### DETAILED DESCRIPTION

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

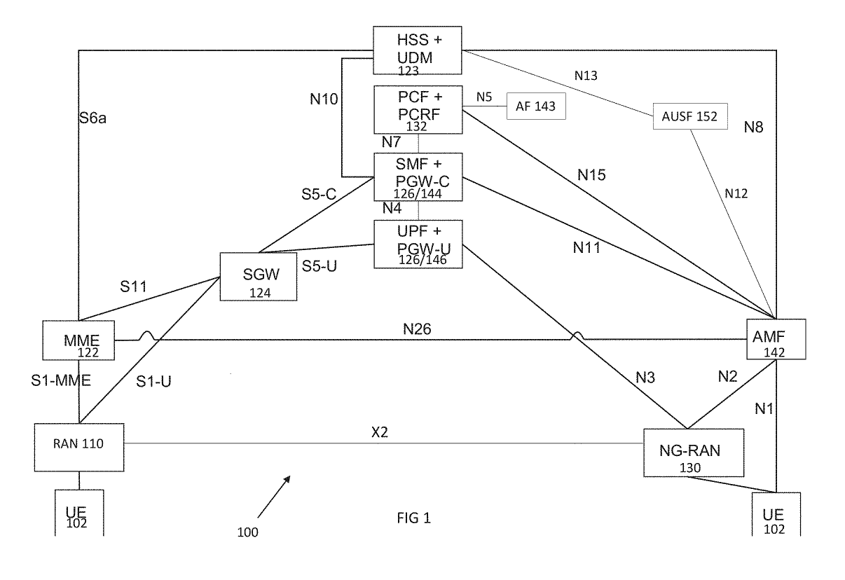

FIG. 1 illustrates a combined communication system in accordance with some embodiments. The system 100 includes 3GPP LTE/4G and NG network functions. A network function can be implemented as a discrete network element on a dedicated hardware, as a software instance running on dedicated hardware, or as a virtualized function instantiated on an appropriate platform, e.g., dedicated hardware or a cloud infrastructure.

The evolved packet core (EPC) of the LTE/4G network contains protocol and reference points defined for each entity. These core network (CN) entities may include a mobility management entity (MME) 122, serving gateway (S-GW) 124, and paging gateway (P-GW) 126.

In the NG network, the control plane and the user plane may be separated, which may permit independent scaling and distribution of the resources of each plane. The UE 102 may be connected to either an access network or random access network (RAN) 110 and/or may be connected to the NG-RAN 130 (gNB) or an Access and Mobility Function (AMF) 142. The RAN may be an eNB, a gNB or a general non-3GPP access point, such as that for Wi-Fi. The NG core network may contain multiple network functions besides the AMF 112. The network functions may include a User Plane Function (UPF) 146, a Session Management Function (SMF) 144, a Policy Control Function (PCF) 132, an Application Function (AF) 148, an Authentication Server Function (AUSF) 152 and User Data Management (UDM) 128. The various elements are connected by the NG reference points shown in FIG. 1.

The AMF 142 may provide UE-based authentication, authorization, mobility management, etc. The AMF 142 may be independent of the access technologies. The SMF 144 may be responsible for session management and allocation of IP addresses to the UE 102. The SMF 144 may also select and control the UPF 146 for data transfer. The SMF 144 may be associated with a single session of the UE 102 or multiple sessions of the UE 102. This is to say that the UE 102 may have multiple 5G sessions. Different SMFs may be allocated to each session. The use of different SMFs may permit each session to be individually managed. As a consequence, the functionalities of each session may be independent of each other. The UPF 126 may be connected with a data network, with which the UE 102 may communicate, the UE 102 transmitting uplink data to or receiving downlink data from the data network.

The AF 148 may provide information on the packet flow to the PCF 132 responsible for policy control to support a desired QoS. The PCF 132 may set mobility and session management policies for the UE 102. To this end, the PCF 132 may use the packet flow information to determine the appropriate policies for proper operation of the AMF 142 and SMF 144. The AUSF 152 may store data for UE authentication. The UDM 128 may similarly store the UE subscription data.

The gNB 130 may be a standalone gNB or a non-standalone gNB, e.g., operating in Dual Connectivity (DC) mode as a booster controlled by the eNB 110 through an X2 or Xn interface. At least some of functionality of the EPC and the NG CN may be shared (alternatively, separate components may be used for each of the combined component shown). The eNB 110 may be connected with an MME 122 of the EPC through an Si interface and with a SGW 124 of the EPC 120 through an S1-U interface. The MME 122 may be connected with an HSS 128 through an S6a interface while the UDM is connected to the AMF 142 through the N8 interface. The SGW 124 may connected with the PGW 126 through an S5 interface (control plane PGW-C through S5-C and user plane PGW-U through S5-U). The PGW 126 may serve as an IP anchor for data through the internet.

The NG CN, as above, may contain an AMF 142, SMF 144 and UPF 146, among others. The eNB 110 and gNB 130 may communicate data with the SGW 124 of the EPC 120 and the UPF 146 of the NG CN. The MME 122 and the AMF 142 may be connected via the N26 interface to provide control information there between, if the N26 interface is supported by the EPC 120. In some embodiments, when the gNB 130 is a standalone gNB, the 5G CN and the EPC 120 may be connected via the N26 interface.

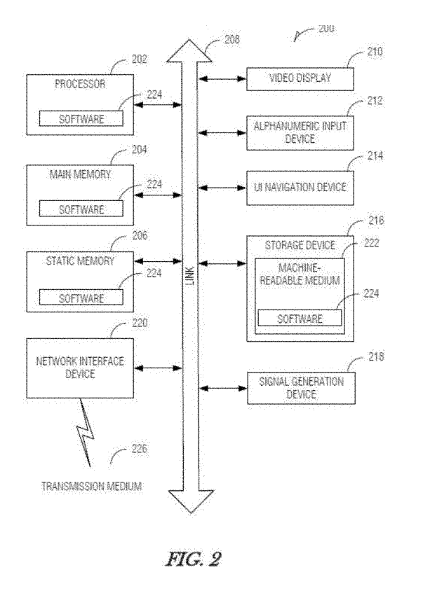

FIG. 2 illustrates a block diagram of a communication device in accordance with some embodiments. In some embodiments, the communication device may be a UE, eNB, gNB or other equipment used in the network environment. For example, the communication device 200 may be a specialized computer, a personal or laptop computer (PC), a tablet PC, a mobile telephone, a smart phone, a network router, switch or bridge, or any machine capable of executing instructions (sequential or otherwise) that specify actions to be taken by that machine. In some embodiments, the communication device 200 may be embedded within other, non-communication based devices such as vehicles and appliances.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, successfully or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a NG/NR standards among others. In an example, the network interface device 220 may include one or more physical jacks (e.g., Ethernet, coaxial, or phone jacks) or one or more antennas to connect to the transmission medium 226.

Networks are designed to operate using different types of access schemes. These access schemes may be classified into non-orthogonal multiple access (NOMA) schemes and orthogonal multiple access (OMA) schemes. Examples of OMA schemes include time-domain multiple access (TDMA), frequency-domain multiple access (FDMA), Orthogonal frequency-division multiple access (OFDMA) and single carrier frequency-domain multiple access (SC-FDMA), among others; while examples of NOMA schemes include 3G code-division multiple access (CDMA) uplinks such as a Wideband Code Division Multiple Access (WCDMA) or High Speed Packet Access (HSPA) uplinks, superposition coding (e.g., Rel-13 NOMA), and the like.

In an OMA scheme, UE multiplexing within a cell may be realized by assigning orthogonal resources to different UEs. In contrast, in a NOMA scheme, UE multiplexing within a cell may be realized by assigning non-orthogonal resources to different UEs. In a NOMA scheme, the resources assigned to different UEs are not orthogonal with each other and thus transmissions from the UEs may interfere with each other by arriving on the same resource. The eNB may use spreading codes. One performance-limiting factor of OMA schemes may be the limited number of orthogonal basis vectors (e.g., the number of time slots in TDMA systems and the number of subcarriers in OFDMA systems), while a similar performance-limiting factor of NOMA schemes may be the total received signal power (depending on the receiver structure) such that a set maximum number of UEs may be able to communicate with the eNB.

Various NOMA schemes are being investigated, including grant-free UL NOMA transmissions and power boosting using UL NOMA transmissions that occupy multiple slots. Grant-free UL NOMA transmissions targets various use cases, including massive connectivity for machine type communication (MTC), support of low overhead UL transmission schemes towards minimizing device power consumption for transmission of small data packets, low latency application such as ultra-reliable and low latency communication (URLLC).

However, if a UE requests a sudden increase in packet size (e.g., for Enhanced Mobile Broadband (eMBB) or URLLC), the use of only grant-free transmission, which is contention-based, may bring about a latency increase due to the shortage of the resources for communication to accommodate the larger packets. Alternatively, the UE may determine that traffic with high reliability or low latency is to be transmitted, and grant-based transmission desired. In this case, the UL NOMA transmission may transition from grant-free transmission to grant-based transmission. To accomplish this, a scheduling grant is provided to the UE by the gNB. The grant requested may typically be triggered by the UE based on a buffer status report (BSR) in a medium access control (MAC) protocol data unit (PDU) of the UE or scheduling request (SR) in the physical layer of the UE. However, when the UE wishes to use more resources than that which can be accommodated by grant-free UL NOMA and the latency incurred through use of the BSR or SR becomes undesirable, another grant request mechanism may be used. A quicker approach may facilitate grant-free UL NOMA UEs that want to transition to grant-based UL transmission.

When using the BSR to make a grant request, the delay involved with waiting for the MAC procedure to respond to the SR may be undesirable. Hence, a quicker approach that utilizes physical layer signaling, via the L1 (physical layer) grant-free transmission by using the control channel, sequence masking the Demodulation Reference Signal (DMRS), dedicated multiple access (MA) signatures, dedicated time-frequency resource, or BSR in L1. Note that the transition from grant-free to grant-based can be initiated by either the UE or the network. In the UE-initiated case, there several options may be used to make a grant-based transmission request (GTR), while the UE is in the grant-free UL NOMA state.

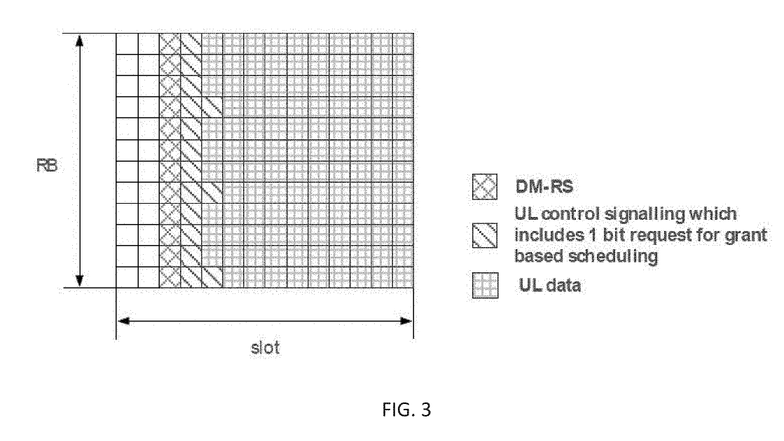

In some embodiments, the UL NOMA control channel may be transmitted in the symbol after the DMRS in each slot. Note that all transmissions between the UE and gNB may be generated and encoded prior to transmission and decoded after reception. FIG. 3 illustrates an UL NOMA transmission in accordance with some embodiments. In FIG. 3, the UL NOMA control channel may contain an additional bit in the uplink control information (UCI). The bit may be used as a flag to indicate the GTR to the gNB. For instance, bit ‘1’ may indicate that the UE requests grant based scheduling while bit ‘0’ may indicate that the UE does not request grant based scheduling. The UL data in the slot may be grant-free UL data, with the UL data associated with the GTR being transmitted one or more subframes later. In some embodiments, the UL control signalling may only include this GTR bit. The resource mapping for UL control signalling for UL NOMA can follow the same rule as UCI on a PUSCH, as defined in NR specification TS 38.212. If a UE transmits the GTR bit and receives a grant from the gNB, the UE may release the grant-free operation and follow the gNB for the grant-based transmission.

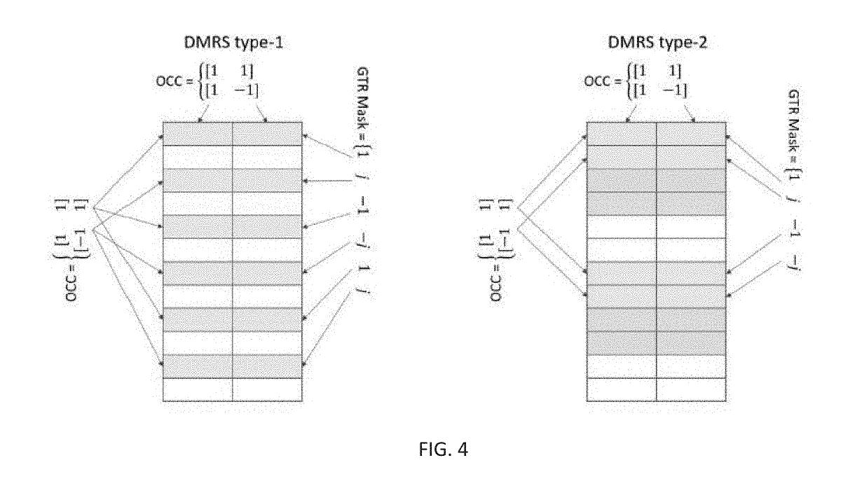

In some embodiments, the UE indicating the GTR to the gNB can apply a sequence mask to the DMRS. FIG. 4 illustrates application of a GTR sequence mask in accordance with some embodiments. In particular, FIG. 4 shows the GTR sequence mask applied to DMRS types 1 and 2. By providing different DMRS in grant-free transmission, the UE can indicate to the gNB whether or not additional grant-based scheduling is desired.

Having established grant-free UL NOMA communication with the gNB, the gNB knows the DMRS of the UE. These DMRS can be multiplexed over the same one or two symbols in a slot using orthogonal 2 sequences in the frequency domain, and a length-2 orthogonal cover code (OCC) in the time domain (if 2 DMRS are used in the slot). When using DMRS type-1, there are two combs over the subcarriers, bringing the total number of ports to 8. When using DMRS type-2, the DMRS are frequency division multiplexed in sets of 2 subcarriers, and each port contains 2 sets of 2 subcarriers with each set separated by 4 subcarriers, which brings the total number of ports to 12. A port is defined as a set of frequency resources (type-1 or type-2), an orthogonal sequence, and an OCC.

For both types of DMRS, the orthogonal sequences in frequency are length-2 ([1, 1], [1, −1]). One embodiment for the mask is for the UE to simply use one of the existing sequences, except multiplied by −1. Hence, instead of using sequence [1, 1] (or [1, −1]), the UE may use sequence [−1, −1] (or [−1, 1]) in its port. However, the total number of ports remains the same.

Another embodiment for the mask is to add another sequence that is orthogonal to the 2 sequences already defined. There are additional orthogonal sequences that exist for each type of DMRS type. Any one of these longer orthogonal sequences can be used to create an additional port for indicating a scheduling request is being made. For example, an OCC of length L can be used if the total number of frequency resources available for the DMRS is divisible by L. For example, the OCC [1, j, −1, −j] of length-4 can be used in conjunction with the existing OCCs. FIG. 2 shows an example for both DMRS types 1 and 2, with n=1 for the GTR sequence number. Note that for DMRS type-1, the total number of PRBs must be a multiple of 2 to use a length-4 OCC. Other OCCs of length-4 also exist, such as [1, 1, −1, −1], or other length OCCs, as long as the length is a factor of the total number of frequency resources available for DMRS across the total bandwidth.

Alternatively, a different DM-RS sequence index or antenna port (AP) index can be used to indicate the grant based scheduling. In particular, two or more than two DM-RS sequences or AP indexes can be configured by higher layers via UE-specific RRC signalling. Further, the UE may select one of two configured DM-RS sequences or AP indexes to make a GTR that is used by the eNB for grant-based scheduling.

In some embodiments, the MA signatures can be used by the UE to make a GTR used by the eNB for grant-based scheduling. The MA signature may include codebook, sequence, and interleaver/scrambler. When using grant-free UL NOMA, each UE may select a MA signature to transmit its data. The pool of available MA signatures may be known to the gNB and all of the UEs. The pool of MA signatures may be partitioned into two sets, one for regular grant-free data transmission without request of grant-based scheduling, and the other for requesting a scheduling grant. The two partitions can be either fixed or configured by the gNB and all UEs participating in grant-free UL NOMA can be informed via Minimum System Information (MSI), Remaining MSI (RMSI), Other System Information (OSI), Radio Resource Control (RRC) signaling, MAC signaling, or L1 signaling such as downlink control information (DCI).

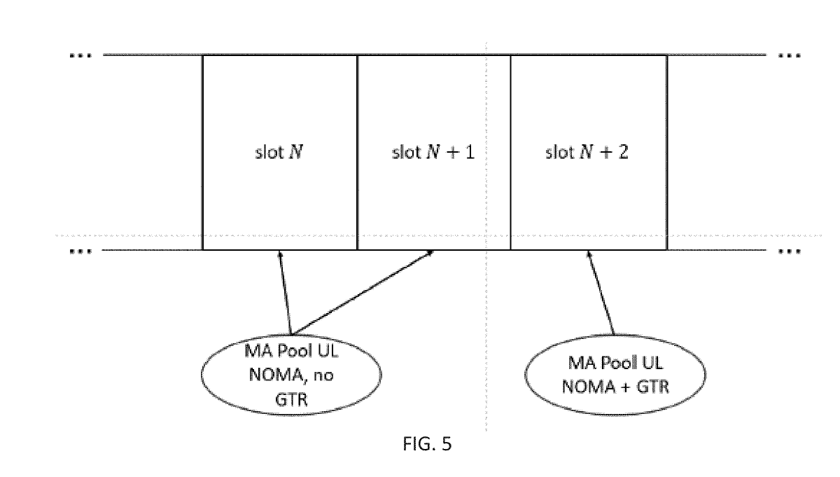

FIG. 5 illustrates GTR use in accordance with some embodiments. In particular, the UE is engaging in GTR by using a MA signature from the NOMA+GTR pool in slot N+2. In FIG. 5, a UE may be engaged in UL NOMA transmission up until slot N+1, when the UE desires a scheduling grant to accommodate an impending packet size increase. The UE may therefore utilize a MA signature from the MA pool reserved for making GTRs (GTR pool) while continuing the current UL NOMA transmission. The gNB may recognize that the data is sent using a MA signature from the GTR pool, and thus can send the scheduling grant to the UE. The resource pool information can be configured by the gNB, and all UEs participating in grant-free UL NOMA can be informed via MSI, RMSI, OSI, RRC, MAC signaling, or L1 signaling such as DCI.

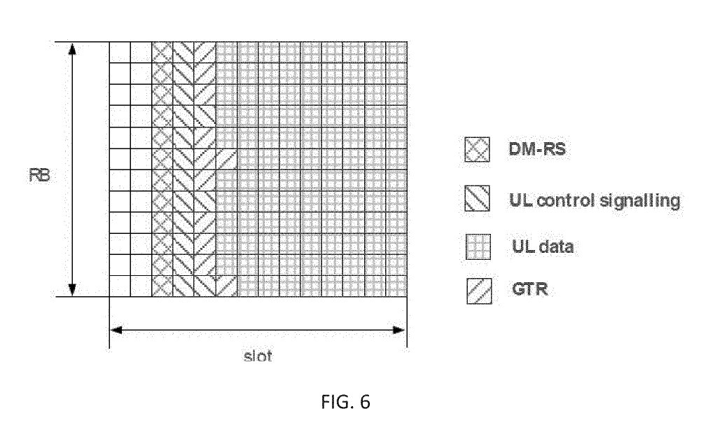

In some embodiments, a special set of resource elements (REs) within the UL-NOMA grant-free RBs can be allocated for the transmission of the GTR. The REs may be called a GTR dedicated channel. FIG. 6 illustrates a GTR dedicated channel in accordance with some embodiments. In some embodiments, as shown in FIG. 6, a set of resource elements can be located in the symbol after the DMRS, where the UEs can transmit GTRs, separated by OCCs over the REs. The GTR resources can span a physical resource block (PRB) or multiple PRBs, depending on the total bandwidth and the expected load of UL NOMA transmissions. This essentially would indicate the GTR as a separate L1 channel, to go along with the L1 control channel and data channel.

Note that the GTR may be transmitted by the UE regardless of whether UL control signalling is present in the UL NOMA. Given that the GTR may carry a single bit, this may puncture the UL data transmission. The resource mapping rule may be similar to the hybrid Automatic Repeat Request-Acknowledgment (HARQ-ACK) mapping on the physical uplink shared channel (PUSCH) with 1 or 2 HARQ-ACK feedback bits, where the HARQ-ACK punctures the UL data.

If both the GTR and UL control signalling are present in the UL NOMA transmission, the GTR may be mapped before or after the UL control signalling. For the latter case, the GTR may be rate-matched around the UL control signalling following the Channel State Information (CSI) part 1 and HARQ-ACK resource mapping on the PUSCH as defined in NR specification. Alternatively, GTR may puncture the UL data or UL control signalling as above.

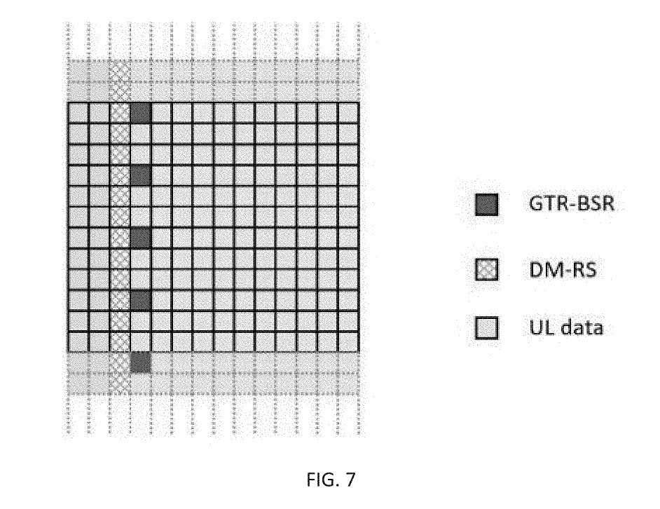

In some embodiments, the GTR information can include more information than just indicating the request to grant-based scheduling. For example, a BSR can be included in the GTR. The multi-bit GTR can be transmitted in the physical layer. In this case, the GTR may be transmitted by puncturing resources inside the UL NOMA data channel. This can be done by a set of REs allocated next to the DMRS, similar to the previous embodiment. FIG. 7 illustrates GTR puncturing in accordance with some embodiments. As shown, the puncturing of the data channel by the GTRs may be in the symbol adjacent to the first DMRS in the slot. The puncturing may occur adjacent to all of the DMRS in a slot, or only adjacent to a specific DMRS in the slot if multiple DMRS are configured per slot. The specific mapping of the puncturing GTRs to the REs can be specified by the gNB periodically. The gNB may configure the GTR mapping according to expected traffic load and GTRs made.

Note that the GTR-related RE used for the various embodiments above are examples. The placement of the flag, dedicated channel and puncturing may differ from that shown. In some embodiments, the placement may be indicated by higher layer signaling or set by the 3GPP standard. The placement may, in some embodiments, change, as determined by the gNB. Similarly, multiple NOMA/GTR pools may be used, as indicated by the gNB, with the use of each pool by the UE conveying additional (and different) information.

In addition to the UL NOMA transitioning from grant-free transmission to grant-based transmission, multi-slot repetition of transport block (TB) transmissions may be supported for the configured grant operation. In a multi-slot transmission, a UE is configured with RRC parameters repK and repK_RV, where repK equals the number of consecutive slots that the UE is to repeatedly transmit a TB, and repK_RV is the redundancy version sequence that the UE is to use when transmitting the TB in the consecutive slots. The parameter repK may be taken from 1, 2, 4, and 8, while the sequences repK_RV may be taken from {0}, {0, 3}, and {0, 2, 3, 1}. The repetitions may continue until repK slots or the RRC configured period in OFDM symbols is reached, whichever comes first.

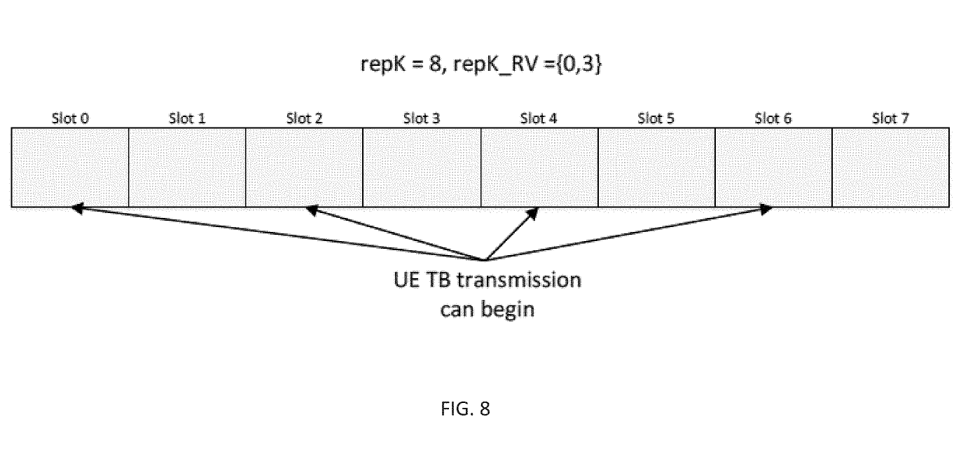

The multi-slot transmission function may help the system increase the cell coverage. However, to improve latency, the UE can begin transmitting its TB in any slot that is a multiple of the length of the redundancy version sequence, except for the case when repK=8 and repK_RV={0}, in which the UE can transmit in any slot except the last. Therefore, if a UE does not have a TB to transmit until a later slot L during the multi-slot transmission slots repK, it can transmit the TB repeatedly for the remaining repK-L+1 slots, according to the repK_RV sequence. FIG. 8 illustrates a multi-slot transmission in accordance with some embodiments. In particular, a multi-slot configuration and flexible starting slot for TB transmission is shown in which repK=8, repK={0,3}. Thus, the UE can begin transmission of the TB during slots 0, 2, 4, or 6, but can only repeat the transmission until slot 7.

For NOMA transmissions, multiple UEs transmit their TB using the same set of time-frequency resources. The receiver at the gNB detects the actively transmitting UEs, estimates the channels, and decodes the information through one of many possible multi-user detection and decoding receiver structures. The receiver structures used by the gNB all employ a form of interference cancellation to improve the signal-to-interference noise ratio (SINR) of each received signal.

Grant-free UL NOMA with multi-slot TB repetition, similar to the configured grant specification, can enable better coverage for NOMA users, while also maintaining the latency. For the NOMA receiver at the gNB to have the same structure, the multi-slot TB repetition configuration may be common amongst the UEs participating in NOMA transmissions. Thus, all UEs participating in UL NOMA transmissions may be provided with the same RRC parameters repK and repK_RV by the gNB. This ensures that the set of transmitted signals all begin and end their transmissions during the same TB repetition period. However, the configuration still allows for flexible transmission of the signal by a UE. Thus, no significant changes need to be made to the receiver.

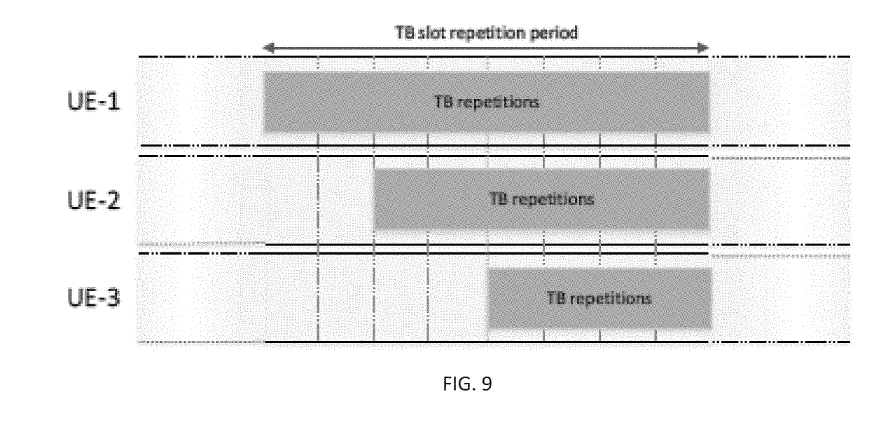

FIG. 9 illustrates multi-slot NOMA TB repetition in accordance with some embodiments. The NOMA transmissions in FIG. 9, as above, are grant-free NOMA transmissions. For UEs transmitting time-sensitive packets, the same flexibility for transmission as with configured grant can be used to reduce latency. However, since advanced NOMA receivers rely on signals having similar or relatively close total received energy to successfully detect and decode the multiple superimposed packet transmissions, the UEs that begin their packet transmissions in a slot after the initial slot of the TB slot repetition period may desire transmit power compensation to have enough accumulated received energy during the TB repetition time period, such that the received signal can be decoded, and subject to the available headroom power for each UE.

The UE can determine its transmission power depending on the starting position of the first transmission of the same TB. If, as shown in FIG. 9, UE_1 starts the transmission from the first position of the repetition period, its transmission power, P_1, can be determined considering all repetition numbers (case 1). However, if UE_1 starts the transmission from a position other than the first position of the repetition period, e.g., 3^{rd} position out of 8 repetitions (case 2), then its transmission power can be increased by a specified power adjustment value (P_adj) from P_1 considering a fewer number of repetitions is used compared to UE_1 in case 1. Therefore, the transmission power of case 1, transmission power of each transmission can be equal to P_1+P_adj, where P_adj is calculated by the number of possible repetitions for case 2.

If the transmission power for UE_1 is defined by:

P_1=min(P_{CMAX}, P_all),

where P_{CMAX} is the configured maximum UE transmit power and P_all is the calculated power at least considering all or some of the following parameters: P_0 value configured by higher layer, alpha, transmission bandwidth, modulation scheme, path-loss estimate, and closed loop power control. Multiple embodiments of power allocation adjustment for UL NOMA transmissions with TB slot repetitions are provided below.

In some embodiments, for the calculation of the power adjustment, P_adj, the ratio of the number of repetition slots remaining L to the total number of repetitions slots K can be used. A power adjustment in dBm can be made as a linear function of this ratio. The adjustment can be added to the equation for P_{O_PUSCH,f,c}(i, j, q_{d}, l) in the NR specification. If the ratio is L/K, then the transmit power adjustment may be described by a relationship:

$${p}_{adj} = ρ ( 1 - \frac{L - 1}{K - 1} ) ,$$

### L=1, . . . , K,

when K>1. The parameter p can be configured by RRC signaling and may be UE specific. Alternatively, a common configuration may be used for an entire group of UEs, and K should be considered when selecting ρ. This may make the power adjustment a subject to the ratio of repetitions used and the total length of the repetitions. If L=K, then clearly there is no power adjustment.

In some embodiments, the UEs can use the ratio L/K, along with their UE specific PUSCH transmit power parameters in P_{O_PUSCH,f,c}(i, j, q_{d}, l), and determine how much additional transmit power should be added based on available headroom and repetition slots remaining. The available headroom power pₕᵣ measured in dBm can be used to derive the power adjustment as a function of L, K and headroom power pₕᵣ measured in dB. The power adjustment function is such that 0≤p_{adj}≤Pₕᵣ for every value of L and K.

One example is a linear function

$${p}_{adj} = {p}_{hr} ( 1 - \frac{L - 1}{K - 1} ) ,$$

L=1, . . . , K. Another such function is an exponential function such as

$${p}_{adj} = {p}_{hr} \frac{{b}^{1 - ( L - 1 ) / ( K - 1 )} - 1}{b - 1} ,$$

b>1, L=1, . . . , K, when K>1, and where the value b is used to make the power adjustment as a function of L more or less distribute the larger power adjustments towards smaller values of L. As above, if L=K, then clearly there is no power adjustment.

In some embodiments, the power adjustment can be configured by higher layers via MSI, RMSI, OSI or RRC signalling. The power adjustment can be added on P_{O_PUSCH,f,c}(i, j, q_{d}, l) in the NR specification.

In some embodiments, the power adjustment may be signaled via group common physical downlink control channel (PDCCH). The gNB may transmit a rule for the UEs to follow (e.g., via a bitmap or table with which the UE is configured/stored in memory). When the UE receives the common for transmit power adjustment, the UE may adjust the transmit power accordingly on the PUSCH transmission. To allow better control of transmit power for NOMA transmission, the bit-width of the transmit power field may be increased so that more levels of the transmit power adjustment can be specified. Alternatively, the maximum transmit power adjustment can be configured by higher layers via MSI, RMSI, OSI or RRC signalling.

Although an aspect has been described with reference to specific example aspects, it will be evident that various modifications and changes may be made to these aspects without departing from the broader scope of the present disclosure. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single aspect for the purpose of streamlining the disclosure. This method of disclosure is not to be interpreted as reflecting an intention that the claimed aspects require more features than are expressly recited in each claim. Rather, as the following claims reflect, inventive subject matter lies in less than all features of a single disclosed aspect. Thus, the following claims are hereby incorporated into the Detailed Description, with each claim standing on its own as a separate aspect.

What is claimed is:

1. An apparatus of a user equipment (UE), the apparatus comprising:
processing circuitry configured to:
determine whether to begin a UE-initiated transition from grant-free uplink (UL) non-orthogonal multiple access (NOMA) transmission to grant-based UL NOMA transmission to a next generation NodeB (gNB);
in response to a determination to transition from grant-free UL NOMA transmission to grant-based UL NOMA transmission, generate an indication of the transition for transmission to the gNB; and
in response to a determination to continue grant-free UL NOMA transmission:
determine NOMA parameters that include:
a number of the repetitions, and
a power of each TB transmission, the power dependent on at least one of a starting position of a first of the TB transmissions and signaling from the gNB; and
configure the UE to generate a grant-free UL NOMA transmission that comprises the repetitions of a transport block (TB) transmission, each TB transmission in accordance with the power, and
a memory configured to store the NOMA parameters.

2. The apparatus of claim 1, wherein the processing circuitry is further configured to:
after transmission of the indication, decode a grant for UL transmission from the gNB, and
in response to reception of the grant, release grant-free operation and generate UL data for transmission to the gNB in accordance with the grant.

3. The apparatus of claim 1, wherein:
the indication is sent before transmission of grant-free UL data in a slot comprising the grant-free UL data, UL control signaling and Demodulation Reference Signals (DMRS).

4. The apparatus of claim 3, wherein:
the indication is sent as an additional bit in uplink control information (UCI) in the UL control signaling, the bit used as a flag to indicate a grant-based transmission request to the gNB.

5. The apparatus of claim 1, wherein the processing circuitry is configured to:
provide the indication by application of a sequence mask to Demodulation Reference Signals (DMRS) such that DMRS associated with grant-free transmission are different from DMRS associated with grant-based transmission.

6. The apparatus of claim 5, wherein at least one of:
the sequence mask multiplies existing orthogonal sequences by −1 with a total number of ports remaining unchanged from before application of the sequence mask,
the sequence mask adds an orthogonal sequence to existing orthogonal sequences used for the DMRS to increase a number of ports used for transmission of the DMRS, or
the sequence mask uses at least one of a DMRS sequence index or antenna port index to provide the indication, the at least one of a DMRS sequence index or antenna port index used to provide the indication different from that used for grant-free transmission.

7. The apparatus of claim 1, wherein the processing circuitry is configured to:
provide the indication by selection of a multiple access (MA) signature from a pool of MA signatures reserved to indicate a grant-based transmission request.

8. The apparatus of claim 1, wherein:
the processing circuitry is configured to provide the indication by use of a set of resource elements within a grant-free resource block reserved to indicate a grant-based transmission request (GTR)
a slot comprises Demodulation Reference Signals (DMRS) and grant-free UL data,
the set of resource elements is adjacent to the DMRS, and

9. The apparatus of claim 8, wherein:
the GTR punctures the grant-free UL data.

10. The apparatus of claim 9, wherein the processing circuitry is configured to:
provide the indication by sending a grant-based transmission request (GTR) to the gNB, the GTR further comprising a buffer status report.

11. The apparatus of claim 10, wherein:
if multiple DMRS are configured per slot, the GTR punctures the grant-free UL data only adjacent to a specific DMRS in the slot, and
mapping of the puncturing GTRs to resource elements is periodically specified by the gNB according to an expected traffic load.

12. The apparatus of claim 1, wherein:
the processing circuitry is configured to provide the indication by use of a set of resource elements within a grant-free resource block reserved to indicate a grant-based transmission request (GTR),
a slot comprises Demodulation Reference Signals (DMRS), UL control signaling after the DMRS, and grant-free UL data after the UL control signaling, and
the set of resource elements is between the UL control signaling and the grant-free UL data.

13. The apparatus of claim 1, wherein:
the power is dependent on the starting position of the first of the TB transmissions, a power adjustment being a linear function of a number of repetition slots remaining to a total number of repetitions slots, a parameter of linearity configured by higher layer signaling from the gNB.

14. The apparatus of claim 13, wherein at least one of:
the parameter is UE specific, or
the power is dependent on the starting position of the first of the TB transmissions, a power adjustment being a function of a number of repetition slots remaining to a total number of repetitions slots and UE-specific physical uplink shared channel (PUSCH) transmit power parameters in P_{O_PUSCH,f,c}(i, j, q_{d}, l) such that transmit power added is based on available headroom (pₕᵣ) and the number of repetition slots remaining.

15. The apparatus of claim 1, wherein:
the power is dependent on the signaling from the gNB, a power adjustment is configured by higher layers via minimum system information (MSI), remaining minimum system information (RMSI), other system information (OSI) or radio resource control (RRC) signalling.

16. The apparatus of claim 1, wherein:
the power is dependent on the signaling from the gNB, a power adjustment is signaled via group common physical downlink control channel (PDCCH).

17. A computer-readable storage medium that stores instructions for execution by one or more processors of a user equipment (UE), the one or more processors to configure the UE to, when the instructions are executed:
determine, while using grant-free uplink (UL) non-orthogonal multiple access (NOMA) transmission in a slot to a next generation NodeB (gNB), whether to transmit to the gNB an indication for a grant-based UL NOMA transmission in a later slot;
in response to a determination to continue grant-free UL NOMA transmission, if the grant-free UL NOMA transmission comprises repetitions of a transport block (TB) transmission, increase a power of the TB transmissions dependent on a number of repetitions remaining and a total number of repetitions; and
send, to the gNB, a grant-based transmission request (GTR) to the gNB and grant-free UL data in the slot if the grant-based UL NOMA transmission is to be used in the later slot and the repetitions of the TB transmission in accordance with the power if the grant-free UL NOMA transmission is to be used in the later slot.

18. The medium of claim 17, wherein the one or more processors further configure the UE to, when the instructions are executed:
the GTR is indicated by one of additional bit in uplink control information (UCI), a sequence mask applied to Demodulation Reference Signals (DMRS), a multiple access (MA) signature, or use of a set of resource elements reserved to indicate the GTR, and
if grant-free UL NOMA transmission is to be used in the later slot, transmit power added to the repetitions of the TB transmission is further based on available headroom (pₕᵣ).

19. An apparatus of a next generation NodeB (gNB), the apparatus comprising:
memory; and processing circuitry configured to:
determine, from a grant-free uplink (UL) non-orthogonal multiple access (NOMA) transmission received in a slot from a user equipment (UE), whether the grant-free UL NOMA transmission contains an indication for a grant-based UL NOMA transmission from the UE in a later slot;
wherein if the grant-free UL NOMA transmission comprises repetitions of a transport block (TB) transmission, a power of the TB transmissions is dependent on higher layer signaling from the gNB, or a total number of repetitions and a number of repetitions remaining; and
wherein, if the grant-free UL NOMA transmission contains the indication, the indication is provided by one of an additional bit in uplink control information (UCI), a sequence mask applied to Demodulation Reference Signals (DMRS), a multiple access (MA) signature, or use of a set of resource elements reserved to indicate a grant-based transmission request (GTR).

20. The apparatus of claim 19, wherein:
if grant-free UL NOMA transmission is to be used in the later slot, transmit power added to the repetitions of the TB transmission is based on the total number of repetitions, the number of repetitions remaining and available headroom (pₕᵣ).
